(19) United States
(12) Patent Application Publication
(10) Pub. No.: US 2024/0362942 A1
(43) Pub. Date: Oct. 31, 2024

(54) METHOD AND SYSTEM FOR PROVIDING NON-VISUAL ACCESS TO GRAPHICAL ARTIFACTS AVAILABLE IN DIGITAL CONTENT

(71) Applicant: UNAR Labs, LLC, Portland, ME (US)

(72) Inventors: Hari Prasath Palani, Portland, ME (US); Owen Thompson, Portland, ME (US); Joyeeta Mitra Mukherjee, Portland, ME (US)

(73) Assignee: UNAR Labs, LLC, Portland, ME (US)

(21) Appl. No.: 18/641,829

(22) Filed: Apr. 22, 2024

Related U.S. Application Data
(60) Provisional application No. 63/498,275, filed on Apr. 26, 2023.

(51) Int. Cl. G06V 30/262; G06F 16/583; G06F 40/30

(52) U.S. Cl. CPC G06V 30/274; G06F 16/5846; G06F 40/30

(57) ABSTRACT

A method for providing non-visual access to graphical artifacts available in digital content includes classifying a graphical artifact into known and/or unknown categories using a deep neural network. The method further includes identifying semantically connected visual and textual components of the graphical artifact, using a deep learning-based object detection model. Furthermore, the method includes extracting the visual and the textual components in a unified framework with predefined semantics associated with each component, using a pre-trained large multi-modal model fine-tuned to extract both the visual and the textual components from an image in the graphical artifact. The method further includes filtering out the predefined semantics through extraction and converting the predefined semantics into accessible representations. Also, the method includes delivering the accessible representations in conformance with requirements of a delivery system.

### CROSS-REFERENCE TO RELATED APPLICATIONS

This application claims the benefit under 35 U.S.C. § 119 (e) of U.S. Provisional Patent Application Ser. No. 63/498,275, filed on Apr. 26, 2023, the contents of which are incorporated herein by reference in their entirety.

### TECHNICAL FIELD

The present invention relates generally to the field of assistive technology. More specifically, the present invention relates to devices, systems, and methods that aid individuals in visually challenging situations to perceive graphical information, such as images, graphs, figures, charts, and diagrams, which are present in digital media sources, such as digital documents, web pages, maps, social media sites, etc.

### BACKGROUND ART

Visually challenging situations, for an individual, may arise due to clinical visual impairment. Alternately, for individuals with healthy vision in normal conditions, visually challenging situations may include limited-light environments, social settings that demand eye-free information access, emergency management, stealth military operations, and management of infotainment systems while driving a car, etc., where information in an image is desired to be obtained from non-visual access. Some technologies enable individuals to have non-visual access to graphical content via combinations of haptic (i.e., touch) and/or auditory representations. Examples of such technologies are provided in references U.S. Pat. No. 9,280,206 and US publication 2017/0212589. However, such technologies are limited to generating and triggering one or more haptic and/or auditory feedback based only on the aesthetic features in an image (e.g., color or object).

Further, the solutions known in the art use Artificial Intelligence (AI) models to extract and combine textual and non-textual information in a document or a query, for formulating answers or achieving other tasks such as recognition, captioning, semantic understanding, etc. While artificial general intelligence (AGI) models have currently achieved a relatively high degree of understanding of natural image content, they are not equally performant on mathematical artifacts. Some of the contributing factors for such a deficiency may include a lack of datasets representing mathematical artifacts in internet-scrubbed data, a lack of appropriate semantic information for mathematical or scientific graphs, and a lack of focus on accessibility and understanding of the semantics needed for making the mathematical artifacts accessible.

Therefore, there is a need for a system that overcomes the disadvantages and limitations associated with the prior art and provides a more satisfactory solution.

### OBJECTS OF THE INVENTION

Some of the objects of the invention are as follows:

An object of the present invention is to provide a method and a system for extracting semantic information from various visual graphical forms encountered in digital media and converting the semantic information into a generic accessible form for storage and delivery to an end-user.

Another object of the invention is to deploy several deep learning models including convolutional neural networks and vision-language transformer-based models for the extraction and conversion of artifacts with mathematical figures to accessible information.

### SUMMARY OF THE INVENTION

According to a first aspect of the present invention, there is provided a method for providing non-visual access to graphical artifacts available in digital content. The method includes classifying a graphical artifact into known and/or unknown categories using a deep neural network. The method further includes identifying semantically connected visual and textual components of the graphical artifact, using a deep learning-based object detection model. Furthermore, the method includes extracting the visual and the textual components in a unified framework with predefined semantics associated with each component, using a pre-trained large multi-modal (LMM) model fine-tuned to extract both the visual and the textual components from an image in the graphical artifact. The method further includes filtering out the predefined semantics through extraction and converting the predefined semantics into accessible representations. The method also includes delivering the accessible representations in conformance with requirements of a delivery system.

In one embodiment of the invention, the graphical artifact is sourced from a plurality of online repositories and/or downloaded from non-transitory storage devices.

In one embodiment of the invention, the graphical artifact is a mathematical or a scientific document with math-related graphics.

In one embodiment of the invention, the visual and the textual components include a figure with a title and footnotes, a paragraph of text, a body of a question, and combinations thereof.

In one embodiment of the invention, the method further includes generating synthetic data using a format of the graphical artifact, a mathematical language, and graphics.

In one embodiment of the invention, the textual components and the associated predefined semantics are extracted using a text-recognition module.

In one embodiment of the invention, the extracted predefined semantics include inflection points, lines, and other predefined semantics.

In one embodiment of the invention, the method further includes querying an image from an image database using the extracted semantics.

In one embodiment of the invention, the accessible representations are selected from a group consisting of braille, audio, haptic representations, and combinations thereof.

In one embodiment of the invention, the delivery system is selected from a group consisting of a vibrator, a contact-based interface, a speaker system, a display out device, and combinations thereof.

According to a second aspect of the present invention, there is provided a system for providing non-visual access to graphical artifacts available in digital content. The system includes a processor, a memory unit operably connected to the processor. The memory unit includes machine-readable instructions, the machine-readable instructions when executed by the processor, enables the processor to classify a graphical artifact into known and/or unknown categories using a deep neural network, identify semantically connected visual and textual components of the graphical artifact, using a deep learning-based object detection model, extract the visual and the textual components in a unified framework with predefined semantics associated with each component, using a pre-trained large multi-modal (LMM) model fine-tuned to extract both the visual and the textual components from an image in the graphical artifact, filter out the predefined semantics through extraction and convert the predefined semantics into accessible representations, and deliver the accessible representations in conformance with requirements of a delivery system.

In one embodiment of the invention, the processor is further configured to source the graphical artifact from a plurality of online repositories and/or download from non-transitory storage devices.

In one embodiment of the invention, the processor is further enabled to generate synthetic data using a format of the graphical artifact, a mathematical language, and graphics.

In one embodiment of the invention, the processor is further configured to extract the textual components and the associated predefined semantics using a text-recognition module.

In one embodiment of the invention, the processor is further configured to query an image from an image database using the extracted semantics.

In the context of the specification, the term “processor” refers to one or more of microprocessors, a GPU (graphics processing unit), a microcontroller, a general-purpose processor, a Field Programmable Gate Array (FPGA) or an Application Specific Integrated Circuit (ASIC), and the like.

In the context of the specification, a phrase including “memory unit”, such as “device memory unit” or “server memory unit”, refers to volatile storage memory, such as Static Random Access Memory (SRAM) and Dynamic Random Access Memory (DRAM) of types such as Asynchronous DRAM, Synchronous DRAM, Double Data Rate SDRAM, Rambus DRAM, and Cache DRAM, etc.,

In the context of the specification, a phrase including “storage unit”, such as “device storage unit” refers to a non-volatile storage device including non-volatile memory such as EPROM, EEPROM, flash memory, or the like.

In the context of the specification, a phrase including “communication interface”, such as “server communication interface” or “device communication interface” refers to a device or a module enabling direct connectivity via wires and connectors such as USB, HDMI, VGA, or wireless connectivity such as Bluetooth or Wi-Fi or Local Area Network (LAN) or Wide Area Network (WAN) implemented through TCP/IP, IEEE 802.x, GSM, CDMA, LTE, or other equivalent protocols.

### BRIEF DESCRIPTION OF THE ACCOMPANYING DRAWINGS

The accompanying drawings depict the optimal approach for implementing the invention as it is currently conceived and described below. To provide a comprehensive understanding of the present invention, please refer to the detailed explanation of the preferred embodiments, which is accompanied by the drawings. Throughout the figures in the drawings, similar reference letters and numerals are utilized to denote corresponding parts.

FIG. 1 illustrates an example architecture of an environment of computing devices in which several embodiments of the present invention may be implemented;

FIG. 2 illustrates an example architecture of a computing device, in accordance with an embodiment of the present invention;

FIG. 3 illustrates a flowchart depicting a method for providing non-visual access to graphical artifacts available in digital content, in accordance with an embodiment of the present invention; and

FIG. 4 illustrates a plurality of modules of machine-readable instructions that would enable a processor to execute method steps of the method illustrated in FIG. 3, in accordance with an embodiment of the present invention.

### DETAILED DESCRIPTION

Embodiments of the present invention disclosure will be described more fully hereinafter with reference to the accompanying drawings in which like numerals represent like elements throughout the figures, and in which example embodiments are shown.

The detailed description and the accompanying drawings illustrate the specific exemplary embodiments by which the disclosure may be practiced. These embodiments are described in detail to enable those skilled in the art to practice the invention illustrated in the disclosure. It is to be understood that other embodiments may be utilized, and other changes may be made, without departing from the spirit or scope of the present disclosure. The following detailed description is therefore not to be taken in a limiting sense, and the scope of the present invention disclosure is defined by the appended claims. Embodiments of the claims may, however, be embodied in many different forms and should not be construed as limited to the embodiments set forth herein.

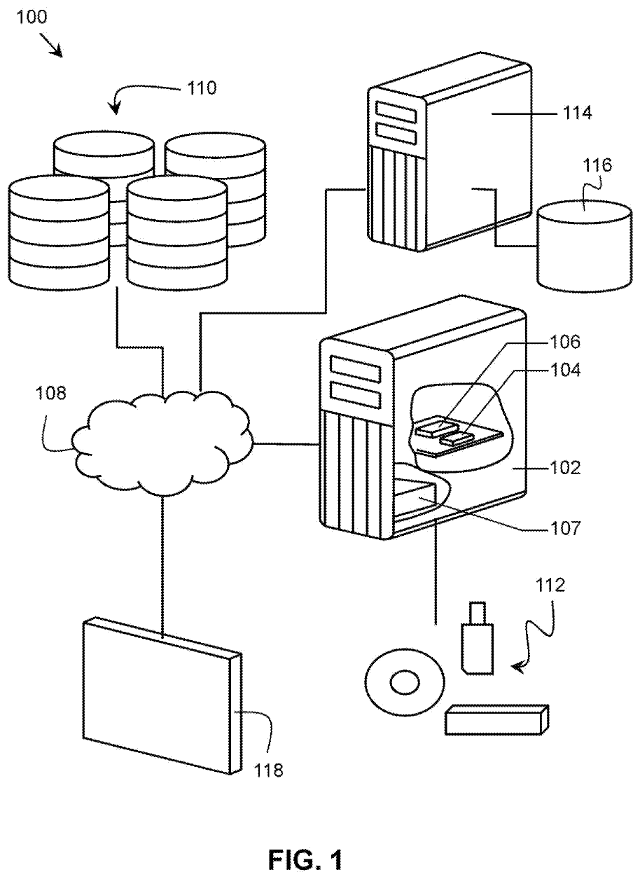

FIG. 1 illustrates an example architecture of an environment 100 of computing devices in which several embodiments of the present invention may be implemented. The environment 100 includes an application server 102. The application server 102 is configured to store and execute an application program including machine-readable instructions for at least partially enabling several embodiments of the present invention. In that regard, the application server 102 includes a server processor 104 and a server memory unit 106. The server memory unit 106 may store the machine-readable instructions of the application program for execution by the server processor 104. The application server 102 may also include a server communication interface 107 enabling connection of the application server 102 with external networks such as a communication network 108. The server communication interface 107 may also allow the application server 102 to connect with non-transitory storage devices 112. The non-transitory storage devices 112 may include CD-ROMs, USB Flash Drives, External Hard Drives, and the like.

The communication network 108 may be a Local Area Network (LAN) or a Wide Area Network (WAN) implemented through combinations of networking protocols such as Wi-Fi, Ethernet, WiMAX, HSDPA, HSPA, LTE, and the like. In several embodiments of the invention, the communication network 108 may be the Internet. Further connected to the communication network 108 is a plurality of online repositories 110. The plurality of online repositories 110 is configured to store digital content in the form of documents, audiovisual media, web pages, tables, and the like. In that regard, the plurality of online repositories 110 may be associated with online scientific journals, social media websites, news media websites, survey-conducting associations, standard-setting organizations, medical databases, and other similar organizations.

Further connected to the communication network 108 is an Application Program Interface (API) server 114. The API server 114 is configured to provide an interface between a program querying for an image and an image database 116. In that regard, the image database 116 may be configured to store a large number of static and moving images in a machine-readable format and may respond to a request sent through the API Server 114 using a querying protocol such as PL-SQL. Also connected with the communication network 108 is a computing device 118. The computing device 118 in that regard may be a smartphone, a tablet PC, a desktop PC, a notebook, and the like.

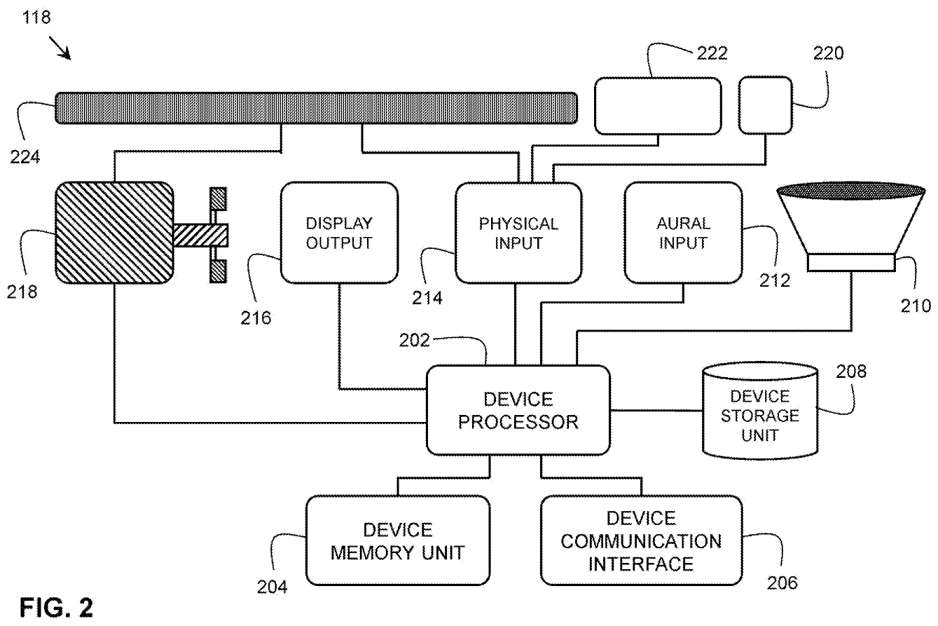

FIG. 2 illustrates an example architecture of the computing device 118, in accordance with an embodiment of the present invention. The computing device 118 includes a device processor 202 operably connected to a device memory unit 204 and a device communication interface 206. Further operably connected to the device processor 202 is a device storage unit 208. The device processor 202 is further connected to a speaker system 210 configured for delivering sound/aural output. The computing device 118 further includes a physical input device 214 configured to deliver inputs from input devices to the device processor 202. In that regard, the physical input device 214 may be connected with a keyboard 222, a pointing device 220 (such as a mouse, a touchpad, a trackball, a joystick, and the like), and a contact-based interface 224.

The contact-based interface 224 may be a resistive contact-based interface or a capacitive contact-based interface. In several embodiments of the invention, the contact-based interface 224 may double as an input device and an output device providing haptic feedback. In several alternate embodiments, the contact-based interface 224 may only act as the output device providing the haptic feedback, and the inputs to the computing device 118, from the user end, may only be received from the keyboard 222 and the pointing device 220. For providing haptic feedback, the contact-based interface 224 may be mechanically coupled with a vibrator 218 controlled by the device processor 202. In several embodiments of the invention, the vibrator 218 may be an Eccentric Rotating Mass (ERM) motor including a mass eccentrically coupled to a motor shaft for generating vibrations used to provide the haptic feedback. The computing device 118 may also include a display output device 216. The display output device 216 may be a Liquid Crystal Display (LCD) based device or a Light Emitting Diode (LED) based output device.

Several embodiments of the present invention have been elucidated in the following description taking the environment 100 and the computing device 118 as a reference. However, a person skilled in the art would appreciate that the present invention can be implemented through several alternate architectures including fewer or more devices and/or functionalities as depicted and/or defined, respectively, through the environment 110 and the computing device 118. It is not essential for practicing the present invention, that all the components illustrated in FIGS. 1 and 2 be present and connected similarly as depicted in FIGS. 1 and 2. The environment 100 and the computing device 118 may take several alternate forms, for example, in which the functionalities of two or more devices may be merged into a single device or functionalities of a single device may be distributed to two or more devices.

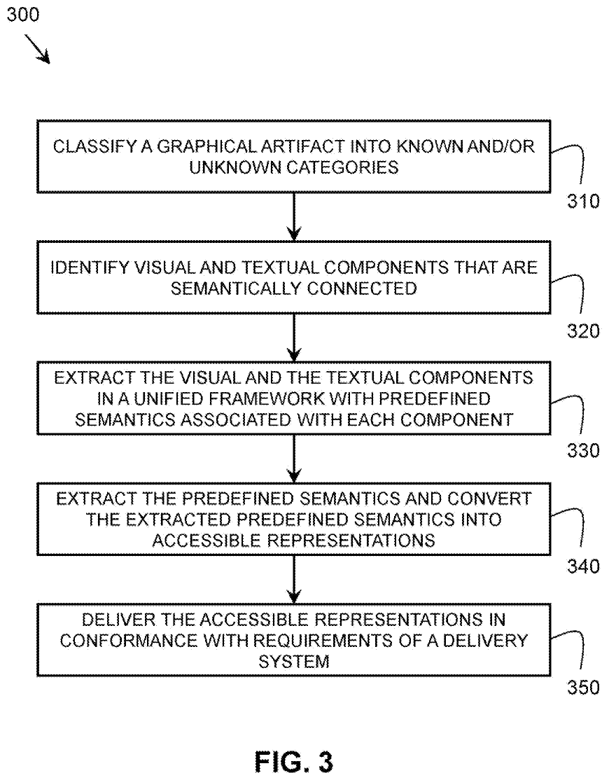

FIG. 3 illustrates a flowchart depicting a method 300 for providing non-visual access to graphical artifacts available in digital content, in accordance with an embodiment of the present invention. The method steps of the method 300 may be executed by one or more processors operably connected with one or more memory units including machine-readable instructions to be executed by the one or more processors. For example, the one or more processors may include one or both of the server processor 104 and the device processor 202, individually or in combination. In that regard, the one or more memory units may include the server memory unit 106 and the device memory unit 204. The machine-readable instructions to execute the method steps may be stored in one or both the server memory unit 106 and the device memory unit 204, individually or in combination.

The method 300 begins at Step 310 when a graphical artifact is classified into known and/or unknown categories. The graphical artifact may be classified using a deep neural network into the known and/or the unknown categories such as math sections, single-column format, multi-column format, etc. The graphical artifact may be sourced, for example, by the server processor 104, from the plurality of online repositories 110. Alternately, the graphical artifact may be provided to the server processor 104 by downloading the graphical artifact from the non-transitory storage devices 112. In several embodiments of the invention, the graphical artifact is a mathematical or a scientific document with math-related graphics.

At Step 320, visual and textual components of the graphical artifact, which are semantically connected, are identified. For example, the visual and the textual components may include a figure with a title and footnotes, a paragraph of text, a body of a question, etc. In that regard, a data generation process focused on mathematical language and graphics is utilized to enable the identification of the visual and the textual components. In that regard, a deep learning-based object detection model may be deployed. Further, the data generation process may be tuned to generate synthetic data using a format of the graphical artifact, a mathematical language, and graphics.

At Step 330, the visual and the textual components are extracted in a unified framework with predefined semantics associated with each component. In several embodiments of the invention, a pre-trained large multi-modal (LMM) model fine-tuned to extract both the visual and the textual components from an image in the graphical artifact, may be utilized. The textual components and the associated predefined semantics, such as a title or a footnote may be extracted using a text-recognition module. The extracted visual and the textual components allow querying sourced data for information like What does this component show? What is the title of the figure? What question or section does this relate to? How many points are in the graph?

At Step 340, the predefined semantics are filtered out through extraction and converted into accessible representations. The extracted predefined semantics may include inflection points, lines, and other predefined semantics. Moreover, the accessible representations may include braille, audio, and/or haptic representations. Further, the extracted semantics may be used to query an image from the image database 116, through the API server 114.

At Step 350, the accessible representations are delivered in conformance with the requirements of a delivery system. For example, the accessible representations may be delivered by the server processor 104 to the device processor 202 through the server communication interface 107, the communication network 108, and the device communication interface 206. The braille and the haptic representations may then be provided to the user by the device processor 202 through the vibrator 218 and the contact-based interface 224. The audio representations may be provided to the user through the speaker system 210. In another example, a multi-line braille display may be provided to the user through the combinational operation of the vibrator 218, the contact-based interface 224, the display out device 216, and the speaker system 210.

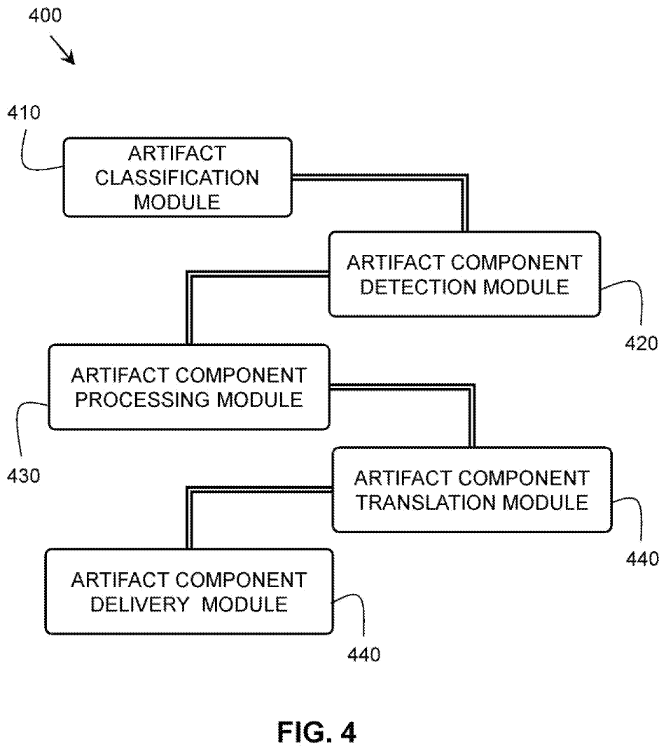

FIG. 4 illustrates a plurality of modules 400 of the machine-readable instructions that would enable a processor (for example, the server processor 104 and/or the device processor 202) to execute the method steps of the method 300 illustrated in FIG. 3, in accordance with an embodiment of the present invention. The plurality of modules 400 includes an artifact classification module 410, an artifact component detection module 420, an artifact component processing module 430, an artifact component translation module 440, and an artifact component deliver module 450. The artifact classification module 410 is configured to classify a graphical artifact into known and/or unknown categories. The artifact component detection module 420 is configured to identify visual and textual components that are semantically connected. The artifact component processing module 430 is configured to extract the visual and the textual components in a unified framework with predefined semantics associated with each component. The artifact component translation module 440 is configured to extract the predefined semantics and convert the extracted predefined semantics into accessible representations. also, the artifact component delivery module is configured to deliver the accessible representations in conformance with the requirements of a delivery system.

Various modifications to these embodiments are apparent to those skilled in the art, from the description and the accompanying drawings. The principles associated with the various embodiments described herein may be applied to other embodiments. Therefore, the description is not intended to be limited to the embodiments shown along with the accompanying drawings but is to be providing the broadest scope consistent with the principles and the novel and inventive features disclosed or suggested herein. Accordingly, the invention is anticipated to hold on to all other such alternatives, modifications, and variations that fall within the scope of the present invention.

1. A method for providing non-visual access to graphical artifacts available in digital content, the method comprising:
classifying a graphical artifact into known and/or unknown categories using a deep neural network;
identifying semantically connected visual and textual components of the graphical artifact, using a deep learning-based object detection model;
extracting the visual and the textual components in a unified framework with predefined semantics associated with each component, using a pre-trained large multi-modal model fine-tuned to extract both the visual and the textual components from an image in the graphical artifact;
filtering out the predefined semantics through extraction and converting the predefined semantics into accessible representations; and
delivering the accessible representations in conformance with requirements of a delivery system.

2. The method as claimed in claim 1, wherein the graphical artifact is sourced from a plurality of online repositories and/or downloaded from non-transitory storage devices.

3. The method as claimed in claim 1, wherein the graphical artifact is a mathematical or a scientific document with math-related graphics.

4. The method as claimed in claim 1, wherein the visual and the textual components comprise a figure with a title and footnotes, a paragraph of text, a body of a question, and combinations thereof.

5. The method as claimed in claim 1, further comprising generating synthetic data using a format of the graphical artifact, a mathematical language, and graphics.

6. The method as claimed in claim 1, wherein the textual components and the associated predefined semantics are extracted using a text-recognition module.

7. The method as claimed in claim 1, wherein the extracted predefined semantics comprise inflection points, lines, and other predefined semantics.

8. The method as claimed in claim 1, further comprising querying an image from an image database using the extracted semantics.

9. The method as claimed in claim 1, wherein the accessible representations are selected from a group consisting of braille, audio, haptic representations, and combinations thereof.

10. The method as claimed in claim 1, wherein the delivery system is selected from a group consisting of a vibrator, a contact-based interface, a speaker system, a display out device, and combinations thereof.

11. A system for providing non-visual access to graphical artifacts available in digital content, the system comprising:
a processor;
a memory unit operably connected to the processor, the memory unit comprising machine-readable instructions, the machine-readable instructions when executed by the processor, enables the processor to:
classify a graphical artifact into known and/or unknown categories using a deep neural network;
identify semantically connected visual and textual components of the graphical artifact, using a deep learning-based object detection model;
extract the visual and the textual components in a unified framework with predefined semantics associated with each component, using a pre-trained large multi-modal model fine-tuned to extract both the visual and the textual components from an image in the graphical artifact;
filter out the predefined semantics through extraction, and convert the predefined semantics into accessible representations; and
deliver the accessible representations in conformance with requirements of a delivery system.

12. The system as claimed in claim 10, wherein the processor is further configured to source the graphical artifact from a plurality of online repositories and/or download from non-transitory storage devices.

13. The system as claimed in claim 10, wherein the graphical artifact is a mathematical or a scientific document with math-related graphics.

14. The system as claimed in claim 10, wherein the visual and the textual components comprise a figure with a title and footnotes, a paragraph of text, a body of a question, and combinations thereof.

15. The system as claimed in claim 10, wherein the processor is further enabled to generate synthetic data using a format of the graphical artifact, a mathematical language, and graphics.

16. The system as claimed in claim 10, wherein the processor is further configured to extract the textual components and the associated predefined semantics using a text-recognition module.

17. The system as claimed in claim 10, wherein the extracted predefined semantics comprise inflection points, lines, and other predefined semantics.

18. The system as claimed in claim 10, wherein the processor is further configured to query an image from an image database using the extracted semantics.

19. The system as claimed in claim 10, wherein the accessible representations are selected from a group consisting of braille, audio, haptic representations, and combinations thereof.

20. The system as claimed in claim 10, wherein the delivery system is selected from a group consisting of a vibrator, a contact-based interface, a speaker system, a display out device, and combinations thereof.
